(19) United States
(12) Patent Application Publication
(10) Pub. No.: US 2015/0083938 A1
(43) Pub. Date: Mar. 26, 2015

(54) COOLER FOR PLASMA GENERATION CHAMBER OF EUV RADIATION SOURCE

(71) Applicant: Carl Zeiss Laser Optics GmbH, Oberkochen (DE)

(72) Inventors: Willi Anderl, Huettlingen (DE); Bernhard Weigl, Steinheim (DE); Ann-Kathrin Wandner, Lorch-Waldhausen (DE); Holger Kierey, Aalen (DE); Arno Schmittner, Koenigsbronn (DE); Markus Bauer, Oberkochen (DE); Marcus Schmelzeisen, Essingen (DE); Andreas Kolloch, Aalen (DE)

(21) Appl. No.: 14/492,949

(22) Filed: Sep. 22, 2014

(30) Foreign Application Priority Data
Sep. 24, 2013 (DE) 102013219185.5

(51) Int. Cl. H05G 2/00; G02B 7/18; F28F 21/08; F28D 15/00; F28F 13/18

(52) U.S. Cl. CPC H05G 2/008; F28D 15/00; F28F 13/185; F28F 21/081; G02B 7/1815
USPC 250/504 R; 165/104.28; 165/133; 165/185; 359/845

(57) ABSTRACT

The disclosure provides a cooler for use in a plasma generation chamber of a radiation source for an extreme ultraviolet wavelength range. The cooler has a heat sink which is at least partially manufactured of a substrate material having a thermal conductivity of greater than 50 W/mK. A coolant duct is formed in the substrate material, and the coolant duct is configured to have a coolant flow therethrough. The cooler also includes a connection piece made of a metal or a metal alloy for connecting a coolant line to the coolant duct. The cooler further includes a connecting element for connecting the connection piece to the heat sink so that, when the connection piece is connected to the heat sink, a continuous line is formed by the coolant duct and the coolant line.

### CROSS-REFERENCE TO RELATED APPLICATION

This application claims priority under 35 U.S.C. §119 to German patent application serial number 102013219185.5, filed on Sep. 24, 2013, the entire disclosure of which is incorporated by reference herein.

### FIELD

The disclosure relates to a cooler or a cooled component for use in a plasma generation chamber of a radiation source for the extreme ultraviolet wavelength range.

### BACKGROUND

Nanostructured and microstructured components for electrical engineering and microsystems engineering are generally produced with the aid of lithographic processes, in which the structures to be generated are imaged on the component on a reduced scale by a mask, which has the structures, via a projection exposure apparatus.

In order to make it possible to satisfy demands for ever smaller structures with adequate resolution, projection exposure apparatuses are increasingly being operated with working light in the extreme ultraviolet (EUV) wavelength range. EUV projection exposure apparatuses of this type place particular demands on the optical elements for beam influencing. By way of example, there are therefore virtually no materials available for producing refractive optical elements which have a sufficient transmittance for EUV wavelength ranges. For this reason, primarily reflective optical elements are used for beam influencing in EUV projection exposure apparatuses. EUV projection exposure apparatuses having reflective optical elements are disclosed, for example, in US 2006/0227826 A1 and in DE 10 2007 052 885 A1.

EUV projection exposure apparatuses use apparatuses for generating electromagnetic radiation in the extreme ultraviolet wavelength range (referred to hereinbelow as “EUV radiation sources”). It is known from the prior art to design EUV radiation sources of this type as LPP (Laser Produced Plasma) radiation sources or as DPP (Discharge Produced Plasma) radiation sources. LPP radiation sources are disclosed, for example, in US 2008/0073598 A1 and DE 10 2011 086 565 A1.

In EUV radiation sources, the plasma for generating radiation is generally generated in a plasma generation chamber, in which it is possible for there to also be optical elements in addition to a mechanism for plasma generation. To protect the optical elements in the plasma generation chamber, a purge gas or cleaning gas is often conducted through the plasma generation chamber. Furthermore, EUV radiation sources often have a subatmospheric-pressure device that can be used to set a subatmospheric pressure (vacuum) in the plasma generation chamber, by virtue of which the quality of the plasma generated is improved. EUV radiation sources having plasma generation chambers, purging apparatuses and subatmospheric-pressure devices are known, for example, from US 2008/0073598 and DE 10 2011 086 565 A1, which have already been mentioned above.

During operation of an EUV radiation source, the components in the plasma generation chamber and the plasma generation chamber itself are exposed to high levels of thermal loading. For this reason, provision is often made of cooling apparatuses for controlling the temperature of components in the plasma generation chamber, these apparatuses being supplied with a cooling medium.

US 2006/0227826 A1 discloses a collector mirror having a cooler for use in a plasma generation chamber of an EUV radiation source. The collector mirror has a substrate with worked-in ducts through which a heat transfer medium can flow. At those points at which the ducts open out into a surface of the collector mirror, the ducts are provided with threads, into which a feed line for the heat transfer medium can easily be bolted.

The cooler of the collector mirror which is disclosed in US 2006/0227826 A1 has the disadvantage that there is the risk of some of the heat transfer medium escaping at the point of connection between the duct in the substrate and the feed line into the plasma generation chamber, where it can be deposited or can accumulate on optically effective surfaces of the optical elements, as a result of which the function of the EUV radiation source and of the EUV projection exposure apparatus is impaired.

DE 10 2009 039 400 A1 discloses a further collector mirror for EUV applications having a cooler with cooling ducts. In the case of this cooler, connections for coolant lines are adhesively bonded on, soldered on or welded on. Since the connection pieces for the coolant lines and the cooler or the collector mirror are often manufactured from different materials, however, they generally have different coefficients of thermal expansion, and therefore changes in temperature during the production or during operation of the cooler give rise to stresses in the connecting layer which can lead to plastic deformation or, in an extreme case, to failure of the connection. Tensile and shear stresses in the adhesive or in the soldered or welded layer can moreover have the effect that minimal leakage ducts present in the layer are widened, and therefore a leakage rate deteriorates with continuing operation of the cooler (in particular in the event of variable thermal loads). An adhesive connection furthermore has the disadvantage that some of the coolant or gases dissolved in the coolant can escape into the surroundings through permeation. In the worst case, this can have the effect that a cooler which has not been rejected upon a final inspection after production becomes leaky during operation and fails.

### SUMMARY

The disclosure seeks to provide a cooler for use in a plasma generation chamber of a radiation source for an extreme ultraviolet wavelength range which is distinguished by improved sealing.

The disclosure also seeks to provide an optical element having a cooler for use in a plasma generation chamber of a radiation source for an extreme ultraviolet wavelength range which is distinguished by improved sealing.

In general, the cooler includes a heat sink, which is at least partially manufactured from a substrate material having a thermal conductivity of greater than 50 W/mK, wherein a coolant duct through which a coolant is to flow is formed in the substrate material. The cooler also includes a connection piece made of a metal or a metal alloy for connecting a coolant line to the coolant duct. The cooler further includes a connecting element for connecting the connection piece to the heat sink, such that, when the connection piece is connected to the heat sink, a continuous line is formed by the coolant duct and the coolant line.

In a cooler according to the disclosure, a first sealing element made of a metallic material or a metal alloy is present. The sealing element is arranged between the heat sink and the connection piece, when the connection piece is connected to the heat sink, and surrounds the continuous line. The cooler also includes a mechanism for protecting the first sealing element against corrosion, in particular by the coolant, are present. Within the context of the present disclosure, “surrounding the continuous line” encompasses surrounding the coolant duct in the heat sink and/or the coolant line in the connection piece and/or arranging the first sealing element between the heat sink and the connection piece in such a way that a continuous line is formed by the coolant duct, the first sealing element and the coolant line.

The use of a first sealing element made of a metallic material or a metal alloy provides a durable, releasable, gas-tight and liquid-tight seal at a transition from the heat sink to the connection piece which has a low leakage rate compared, for example, to the use of elastomeric sealing elements when the cooler is used in a plasma generation chamber. The mechanism for protecting the first sealing element against corrosion prevent premature failure of the first sealing element as a consequence of contact between the first sealing element and a coolant in the coolant line.

In one embodiment of the disclosure, the substrate material includes a ceramic substrate. Ceramic substrates are distinguished by low thermal expansion, a high thermal conductivity, a high modulus of elasticity, a low density, good dimensional stability under the conditions which prevail in the plasma generation chamber and a high chemical resistance in a plasma environment (in particular also to corrosion), and therefore they are particularly suitable for use in coolers for EUV applications.

In a further embodiment of the disclosure, the heat sink has a first contact surface for the first sealing element which has concentric roughness structures. The first contact surface is produced in particular via a mechanical or chemical machining process which leads to microscopically small, concentric roughness structures, in particular grooves, in the contact surface. Examples of such machining processes are grinding or erosion, and also turning or milling in the case of coolers made of a metal, a metal alloy or a metal composite substrate. The concentric roughness structures can be formed around the center of the continuous line formed by the coolant duct and the coolant line or around other points in the first contact surface. The selection of a machining process which leads to concentric roughness structures in the first contact surface minimizes a leakage rate as a consequence of roughness structures or grooves running radially with respect to the continuous line, and therefore a seal between the first contact surface and the first sealing element is improved in the radial direction.

In a further embodiment of the disclosure, the heat sink has a first flange and the connection piece has a second flange, wherein the heat sink and the connection piece are connected to one another via the first flange and the second flange. The connecting element is embodied in such a manner that normal forces can be exerted on opposing surfaces of the first flange and of the second flange by the connecting element. For this purpose, the connecting element can be in the form of a continuous element (for example in the form of a bolt with a nut and washer) and can be guided through aligned boreholes or openings in the first flange and in the second flange. As an alternative, the connecting element can also be in the form of a bracket or ferrule which engages around the first flange and the second flange. This embodiment of the disclosure affords the advantage that lesser tensile stresses arise in the heat sink compared to a connecting element which has been bolted in. The embodiment is suitable in particular when the heat sink has been manufactured from a ceramic substrate, since this material is sensitive to tensile loading. In a further embodiment of the disclosure, the substrate material comprises a metal, a metal alloy and/or a metal composite substrate. These materials are likewise distinguished by low thermal expansion, a good thermal conductivity and good dimensional stability under the prevailing EUV conditions, and therefore they are readily suitable for use in coolers for EUV applications, in particular also for non-optically effective, cooled elements.

In a further embodiment of the disclosure, the first sealing element has a cross section in the form of a closed or open hollow profile. On account of its shaping, the first sealing element thereby has an increased spring action compared to a solid profile upon external loading. If, when the heat sink is being joined together with the connection piece, a normal force is exerted on the first sealing element, for example with the aid of the connecting element, said sealing element deforms, such that the contact surfaces between the first sealing element and the heat sink and also between the first sealing element and the connection piece are enlarged. This improves the seal.

In a further embodiment of the disclosure, the mechanism for protecting the first sealing element against corrosion comprise a second sealing element, which has a liquid-tight embodiment and surrounds the continuous line formed by the coolant duct in the heat sink and the coolant line in the connection piece and which is arranged between the first sealing element and the continuous line. This reduces the risk in particular of liquid constituents of the coolant passing from the continuous line to the first sealing mechanism, and therefore corrosion of the first sealing element is at least largely prevented. It is sufficient in this respect if the second sealing element has a liquid-tight design; a gas-tight embodiment of the second sealing element is not absolutely necessary, since any gaseous constituents of the cooling medium which penetrate the second sealing element, for example by permeation, are reliably held back by the first sealing element made of a metallic material or a metal alloy. In addition, an embodiment comprising a first and a second sealing element affords the advantage that a residual protective action still remains after failure of one of the two sealing elements.

In a further embodiment of the disclosure, the second sealing element is embodied as an O ring. Commercially available O rings represent a very cost-effective and easily implementable way of sealing primarily against liquid coolant constituents. However, they often provide only minor protection against gaseous coolant constituents, since gaseous media may pass through in particular through permeation. In the cooler according to the disclosure, however, any gaseous media which have passed through are effectively held back by the subsequent first sealing element. In cooperation with the first sealing element, provision is therefore made of a cost-effective and effective seal for applications in a cooler for use in a plasma generation chamber.

In a further embodiment of the disclosure, the heat sink has a second contact surface for the second sealing element which has concentric roughness structures. The second contact surface is produced in particular via a mechanical or chemical machining process which leads to microscopically small, concentric roughness structures, in particular grooves, in the contact surface. Examples of such machining processes are grinding or erosion, and also turning or milling in the case of coolers made of a metal, a metal alloy or a metal composite substrate. The concentric roughness structures can in particular also be formed around the center of the continuous line formed by the coolant duct and the coolant line or around other points in the second contact surface. The selection of a machining process which leads to concentric roughness structures in the second contact surface minimizes the number of roughness structures or grooves running radially with respect to the continuous line, and therefore a seal between the second contact surface and the second sealing element is improved in the radial direction.

In a further embodiment of the disclosure, the mechanism for protecting the first sealing element against corrosion comprise a corrosion-inhibiting coating of the first sealing element. In this way, the risk of contact corrosion with subsequent leakages in particular when liquid coolant is used is reduced. This prevents premature failure of the first sealing element as a consequence of contact between the first sealing element and a coolant in the coolant line.

In a reflective optical element according to the disclosure having a cooler for use in a plasma generation chamber of a radiation source for an extreme ultraviolet wavelength range, the cooler is embodied as described herein.

### BRIEF DESCRIPTION OF THE DRAWINGS

Hereinbelow, exemplary embodiments of the disclosure will be explained in more detail on the basis of drawings, in which:

FIG. 1 shows a schematic illustration of a projection exposure apparatus for EUV applications;

FIG. 2 shows a schematic illustration of a plasma generation chamber having a cooler according to the disclosure;

FIG. 3 shows an embodiment of a connection of a connection piece to a heat sink;

FIG. 4 shows a further embodiment of a connection of a connection piece to a heat sink;

FIG. 5 shows a further embodiment of a connection of a connection piece to a heat sink configured as a flange;

FIG. 6 shows a further embodiment of a connection of a connection piece to a heat sink configured as a flange;

FIG. 7 shows a further embodiment of a connection of a connection piece to a heat sink with a first sealing element and a second sealing element;

FIG. 8 shows a further embodiment of a connection of a connection piece to a heat sink;

FIG. 9 shows an offset connection of a connection piece to a heat sink;

FIG. 10 shows the connection shown in FIG. 9 in a section along the line A-A from FIG. 9;

FIG. 11 shows a further embodiment of a connection of a connection piece to a heat sink with a shrunk-on coolant line;

FIG. 12 shows a further embodiment of a connection of a connection piece to a heat sink with a shrunk-in coolant line;

FIG. 13 shows a further embodiment of a connection of a connection piece to a heat sink with sealing elements arranged axially in relation to the continuous line; and

FIG. 14 shows a detailed illustration of a connection surface in a heat sink for a sealing element.

### DETAILED DESCRIPTION

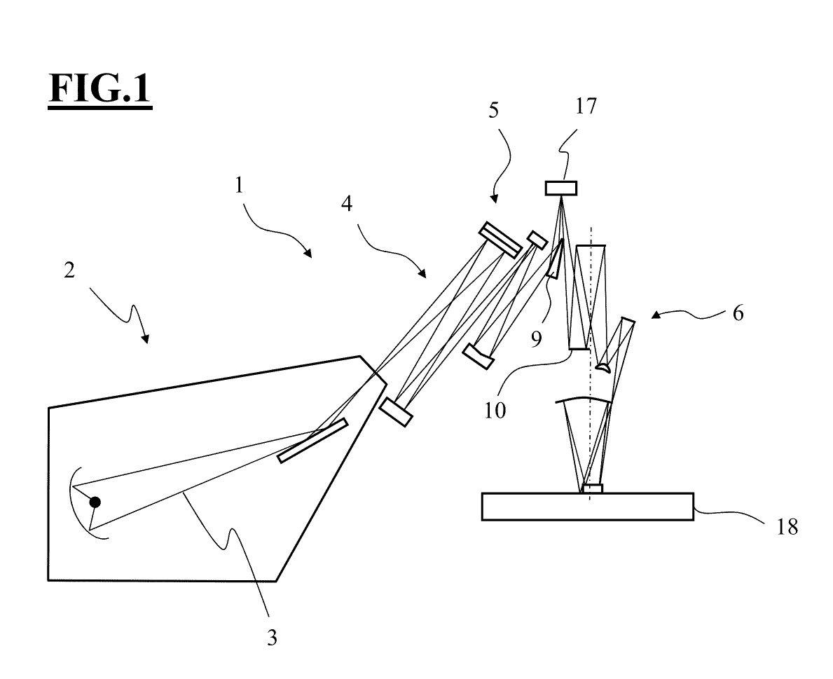

Firstly, the fundamental design of a microlithographic EUV projection exposure apparatus will be described with reference to FIG. 1. A projection exposure apparatus 1 of this type has an EUV radiation source 2, in which electromagnetic radiation in an EUV wavelength range, i.e. with a wavelength of between 10 and 15 nm, in particular with a wavelength of 13.5 nm, is generated, concentrated and emitted in the direction of an illumination system 4. The illumination system 4 includes a first group of mirrors 5, with the aid of which the EUV beam is shaped, such that a mask 17 is illuminated. The mask 17 bears a microstructure which is imaged onto a wafer 18 on a reduced scale. The mask 17 is imaged onto the wafer 18 with the aid of a projection optical unit 16 made up of a second group of mirrors 6.

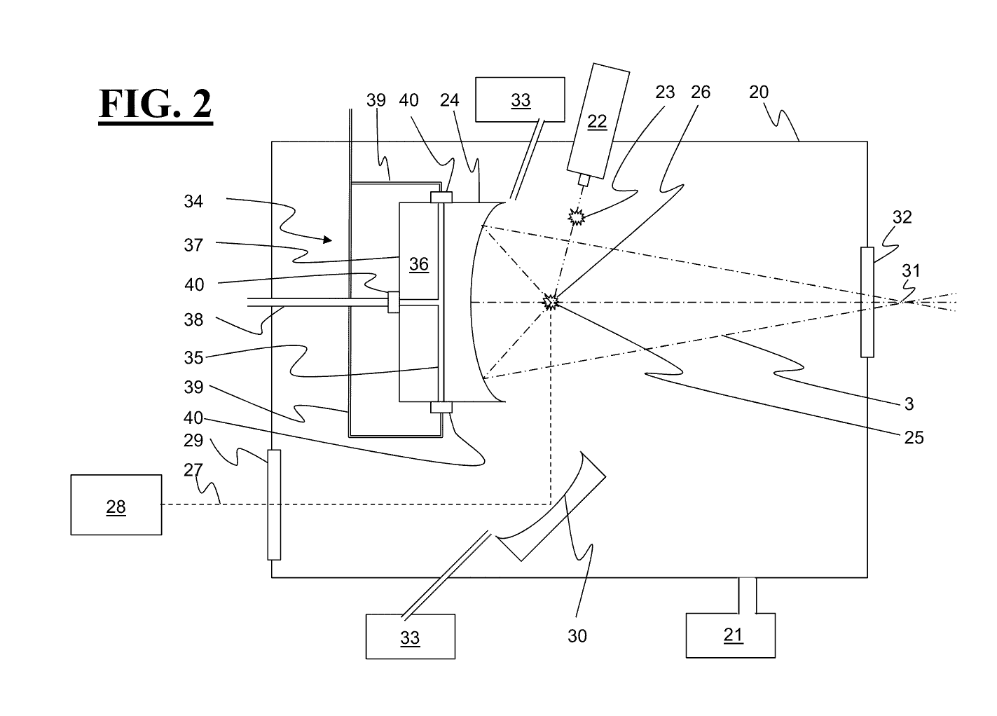

FIG. 2 shows, by way of example, the design of an EUV radiation source 2. The EUV radiation source is designed as an LPP radiation source and comprises a plasma generation chamber 20, in which the plasma is formed. A vacuum pump 21 can be used to generate a subatmospheric pressure, which can be, for example, 1 mbar or less, in the plasma generation chamber 20. This facilitates the formation of a plasma. The reduced number of mobile particles in the plasma generation chamber, which is caused by the subatmospheric pressure, moreover leads to reduced absorption of the EUV radiation.

A plasma generation material 23 can be introduced, preferably in droplets, into the plasma generation chamber with the aid of an injection apparatus 22. Tin Sn or gadolinium Gd can be used, for example, as the plasma generation material 23. The injection apparatus 22 is formed and oriented in this case in such a way that the droplets 26 of the plasma generation material 23 which are released by the injection apparatus 22 are conveyed into a first focal point 25 of an ellipsoidal collector 24.

A laser 28 preferably operating in a pulsed fashion is arranged outside the plasma generation chamber and can be used to generate a laser beam 27, which can be guided through an entrance window 29 into the plasma generation chamber 20. After it has entered the plasma generation chamber 20, the laser beam 27 is deflected at a mirror 30 in the direction of the first focal point of the collector 24. The cycle rates and the orientations of the laser 28 and of the injection apparatus 22 are in this case synchronized with one another in such a way that the laser beam is incident on a droplet 26 of the plasma generation material 23 in the first focal point or as close as possible to the first focal point. The droplet 26 evaporates abruptly as a result of the laser irradiation, creating EUV radiation 3.

The EUV radiation 3 generated in this way is initially non-directional. A large part of the EUV radiation is concentrated by the collector and focused, after passing through an exit hole 32 of the plasma generation chamber 20, in a second focal point 31 of the ellipsoidal collector 24.

The collector 24 in particular, in the immediate vicinity of which the plasma is generated, is exposed to high thermal loading and also high radiation loading and possible bombardment by droplets or droplet residues of the plasma generation material or chemical reaction components thereof, and therefore damage can occur in particular on the surface of the collector and deposits can form. This also applies to a diminished extent to the other optical elements arranged in the plasma generation chamber, such as the mirror 30. Damage or deposits of this nature impair the reflection behavior of the optical elements and lead to a deterioration in the efficiency of the EUV projection exposure apparatus. In order to reduce this risk, the EUV radiation source 2 has purging apparatuses 33, which make it possible to supply a purge gas for protecting the optical components. The purge gas used can be, for example, inert, inactive gases such as argon Ar, helium He, nitrogen N2 or krypton Kr, or else reactive gases such as H₂, with the aid of which it is possible in particular to bring about a cleaning chemical reaction with the deposits present on the surfaces of the optical elements. The gases may be supplied as plasma. Hydrogen plasma is particularly well suited to clean the surface of the collector from tin or other deposits.

On account of the high thermal loading, optical elements in a plasma generation chamber often comprise a cooler or they are coupled to a cooler via heat-conducting connections. In this exemplary embodiment, the collector 24 comprises a cooler 34 having a heat sink 37 made of a substrate material 36, into which a cooling duct 35 has been worked. The cooler is designed to dissipate quantities of heat of 10 kW and more. The substrate material 36 used is preferably a material having a thermal conductivity of more than 50 W/mK, in order to ensure a good transfer of heat from a reflective surface of the collector to the cooling duct 35 in the substrate material 36. In particular, the substrate material can comprise a ceramic material such as silicon carbide SiC or silicon-infiltrated silicon carbide SiSiC. As an alternative or in addition, the substrate material used can also be a metal composite substrate, in particular aluminum with silicon carbide or silicon dispersion reinforcement AlSiC or AlSi, or a metal substrate made of aluminum or an aluminum alloy such as AlSi1MgMn. Other possible metallic substrate materials are copper, molybdenum, tungsten, beryllium or alloys consisting of said materials. Metal substrates are distinguished by low costs in production and processing.

A cooling medium can flow through the cooling duct 35 and can be fed to and carried away from the cooler via coolant lines 38, 39. In this exemplary embodiment, the cooling medium provided is water. The coolant lines 38, 39 are preferably produced from high-grade steel and can comprise various flow-conducting elements such as pipes, vacuum feedthroughs or bellows.

The coolant lines 38, 39 are connected to the heat sink 37 via connection pieces 40, the connection pieces 40 being configured either as a separate connecting piece having a first connection for connecting to the heat sink and a second connection for connecting to the coolant line 38, 39 or as an integral component part of the coolant line 38, 39. If the connection piece is formed as a separate connecting piece, the coolant lines 38, 39 can be connected for example via a VCR seal made of high-grade steel.

If the cooler and the reflective optical element are embodied as an integral component, inlet and outlet openings of the cooling duct and also the connection pieces assigned to the inlet and outlet openings are preferably arranged, as shown in FIG. 2, on those sides of the cooler 34 which are remote from the reflective side. In this way, connection forces which can arise at the points of connection between the coolant line and the heat sink are kept away from the optically effective side of the optical element, and therefore the risk of deformation is reduced.

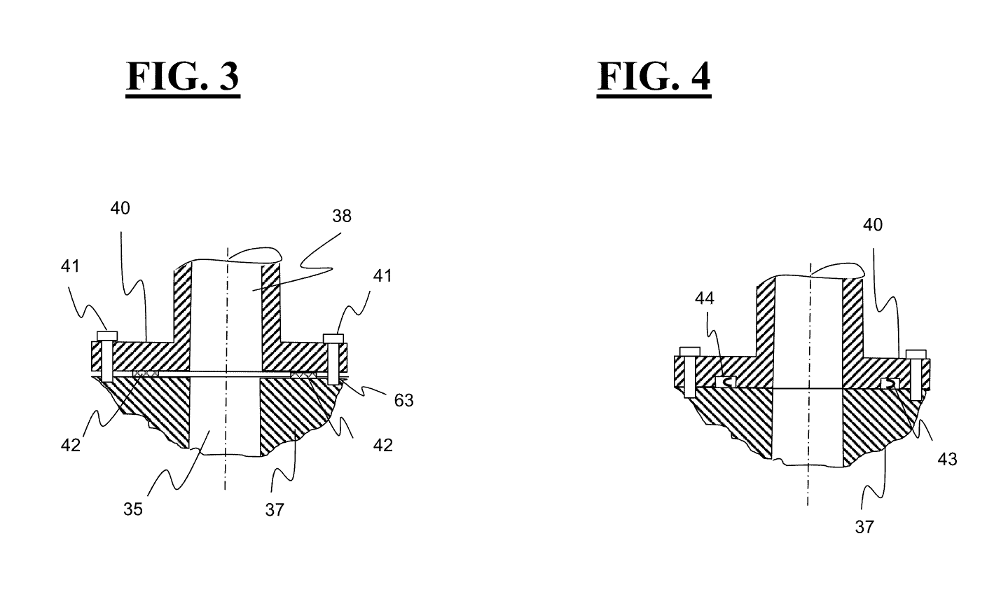

The basic principle of a seal between a connection piece and the heat sink in a cooler according to the disclosure will be explained hereinbelow on the basis of FIG. 3.

The connection piece 40 for the coolant line 38 is connected to the heat sink 37 of the cooler 34 via connecting elements in the form of a bolted connection 41. In this exemplary embodiment, the coolant line 38 and the connection piece 40 are embodied as an integral component. The connection piece 40 and the heat sink 37 are aligned in relation to one another in such a manner that, when a connection is made, a continuous line is formed by the coolant duct 35 and the coolant line 38. The term “continuous line” is to be understood in this respect as meaning that coolant can pass over from the coolant line into the cooling duct, or vice versa, in the line.

A first sealing element in the form of a ring 42 made of a metal or a metal alloy is arranged between the connection piece 40 and the heat sink 37, said ring surrounding the continuous line formed by the coolant duct and the coolant line at the point of connection between the connection piece 40 and the heat sink 37, and thereby providing a seal with respect to the plasma generation chamber. The ring 42 is preferably produced from copper or a soft metal such as indium and can have any desired, including a non-circular, closed form.

With the aid of the bolted connection 41, the connection piece 40 is held securely on the heat sink 37. In addition, a normal force can be exerted on the ring 42 by way of the bolted connection, such that the ring 42 is prestressed. As a result, the sealing action is improved even when pressure and temperature fluctuations arise during operation of the cooler in the plasma generation chamber and/or during production of the cooler.

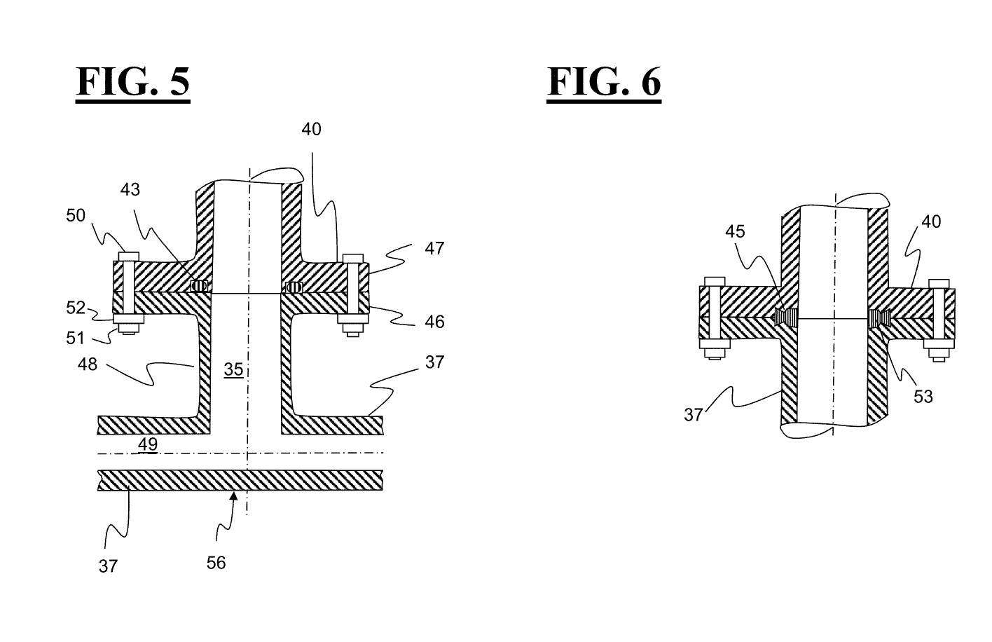

In the exemplary embodiment as shown in FIG. 3, a threaded insert 63, into which the bolt of the bolted connection 41 engages, is adhesively bonded, soldered or cast into the heat sink. The threaded insert 63 is preferably secured against being pulled out by an undercut. As an alternative, the connecting element can also be embodied as a continuous bolted connection on a flange (shown by way of example in FIG. 5). In further exemplary embodiments which are not shown, rivets are provided as connecting elements.

To protect against corrosion, the first sealing element has a corrosion-inhibiting coating, this preferably consisting of a soft material such that it is impressed into roughness structures present in the surfaces during the connection of the connection piece to the heat sink. This improves a sealing action. The coating can comprise, for example, polytetrafluoroethylene (PTFE) or consist of PTFE.

FIGS. 4 and 5 show an alternative or additional seal. The exemplary embodiment shown in FIG. 4 differs from that shown in FIG. 3 in that the connecting element is embodied in the form of a profiled ring 43 made of a metallic material or a metal alloy. In this example, the ring has a C-shaped profile. Without loss of generality, however, the ring can also be embodied with a round or oval profile (see FIG. 5) as a solid or hollow profile or with a U-shaped cross section. The profile of the ring can also be occupied by another, in particular elastic, material or by an elastic structure.

The profiled ring 43 is arranged in a circumferential groove 44 in the connection piece 40, the cross section of the profiled ring 43 preferably being designed so as to be slightly larger than the cross section of the circumferential groove 44, such that the profiled ring is compressed when the heat sink is connected to the connection piece. As a result, the contact surfaces between the profiled ring 43 and the heat sink 37 or the connection piece 40 are enlarged, as a result of which the sealing action is improved. In a manner similar to the exemplary embodiment shown in FIG. 3, the profiled ring 43 is provided with a corrosion-inhibiting coating, this preferably consisting of a soft material such that it is impressed into roughness structures present in the surfaces during the connection of the connection piece to the heat sink. This improves a sealing action. The coating can comprise, for example, polytetrafluoroethylene (PTFE) or consist of PTFE.

In the exemplary embodiment as shown in FIG. 5, the heat sink 37 has a connecting line 48 with a coolant duct 35 which branches off from a main coolant duct 49 in the heat sink 37. The main coolant duct 49 runs close to a surface 56 of the heat sink 37, via which a large part of the heat to be dissipated is taken up during operation. The surface 56 can be embodied in particular as a reflective surface of a mirror, in particular of a collector mirror.

The coolant duct 35 opens out into an opening in a first flange 46. The connection piece 40 comprises a second flange 47 adapted in terms of shape to the first flange 46. The formation of the cooler with a first flange 46 and a second flange 47 at the point of connection between the heat sink 37 and the connection piece 40 makes it possible, as shown in FIG. 5, to use continuous connecting elements for connecting the connection piece 40 to the heat sink 37. In the exemplary embodiment as shown in FIG. 5, the connecting elements provided are bolts 50 with nuts 51 and washers or backing pieces 52. Compared to the connections shown in FIGS. 3 and 4, in which connecting elements are bolted into the heat sink 37, continuous connecting elements make it possible to generate greater normal forces at the sealing points, as a result of which a sealing action of the first sealing element is improved. The contact surfaces on the heat sink 37 toward the washers or backing pieces are preferably machined in such a way that the smoothest possible surface is formed. This makes it possible to reduce tensile stresses in the heat sink as a consequence of notch effects during the connection of the heat sink to the connection piece, this being important in particular when the cooler is designed with a ceramic as the substrate material. The flanges 46, 47 are preferably supported with respect to the connecting line 48 and/or the heat sink by ribs or other supporting structures (not shown in FIG. 5). All of the sealing elements which are presented in this document can be used in flange connections as shown in FIG. 5 or in attached connections as shown in FIG. 3 or 4.

FIG. 6 shows an alternative embodiment of a seal between the connection piece and the heat sink of a cooler according to the disclosure. In this case, the first sealing element is embodied in a basic form as a flat disk 53. In the connection piece 40 and/or in the heat sink 37, the contact surfaces for the seal are provided with a circumferential cutting edge 45, which is pressed into the disk 53 during the connection of the connection piece 40 to the heat sink 37. The disk 53 is in this case preferably manufactured from a soft metallic material such as copper and has, for example, a rectangular cross section before pressing. In a manner similar to the exemplary embodiment as shown in FIG. 3, the disk 53 is provided with a corrosion-inhibiting coating.

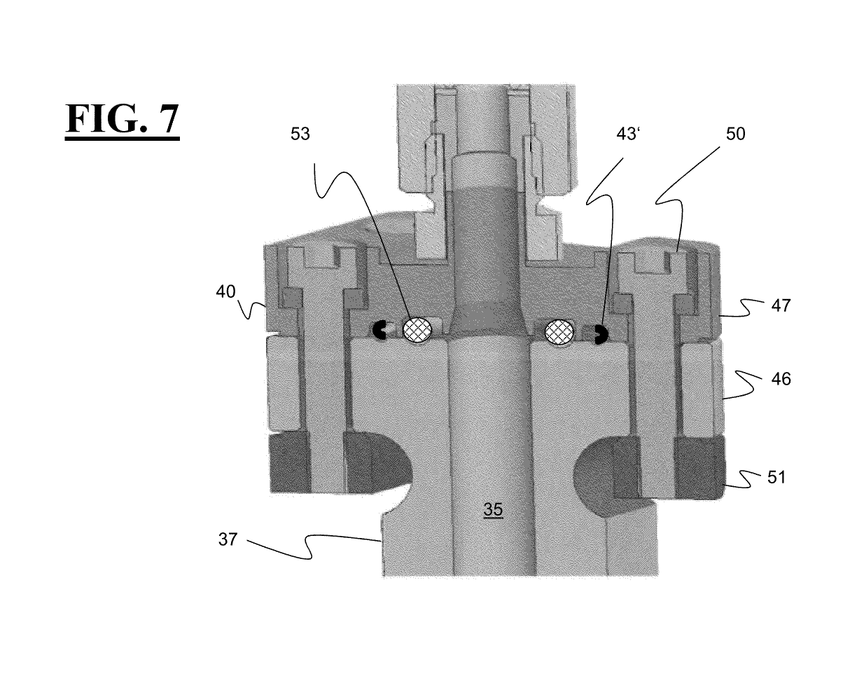

FIG. 7 shows a further exemplary embodiment of a cooler having a seal between the connection piece and the heat sink. This exemplary embodiment differs from the above-described exemplary embodiments in that the mechanism for protecting the first sealing element against corrosion comprise a second sealing element in the form of an O ring 53, which surrounds the continuous line formed by the coolant duct and the coolant line and is arranged between the first sealing element and the continuous line.

In this exemplary embodiment, the first sealing element is embodied as a profiled ring 43′ having an open hollow profile. In further exemplary embodiments which are not shown, the first sealing element can also be formed as a closed hollow profile, as a disk or in another form. In yet another exemplary embodiment which is not shown, the first sealing element is embodied as a ring having a closed hollow profile and is filled with an elastic material and/or an elastic structure in the interior of the hollow profile. This improves a spring action of the ring. A significant difference between this exemplary embodiment and the above-described exemplary embodiments consists in the fact that the first sealing element can be provided, but does not have to be provided, with a corrosion-inhibiting coating, since the second sealing element is already present as a mechanism for protecting the first sealing element against corrosion.

The heat sink 37 has a first flange 46 for connecting the connection piece 40. The connection piece 40 is equipped with a second flange 47, the shapes of the contact surfaces of the first flange 46 and of the second flange 47 being adapted to one another. The connection piece 40 and the heat sink 37 are connected to one another by way of continuous bolted connections at the flanges. By tightening the bolted connections, it is possible to generate a relatively large normal force on the profiled ring 43′ and the O ring 53, as a result of which the sealing action is improved.

The O ring 53 reduces the risk in particular of liquid constituents of the coolant, in particular water, penetrating from the continuous line to the profiled ring 43′, and therefore corrosion of the profiled ring 43′ is at least largely prevented. The combination of a liquid-tight, but not necessarily gas-tight, second sealing element and a gas-tight first sealing element made of a metal or a metal alloy provides a highly effective seal, which is suitable in particular when the cooler is used in a plasma generation chamber under the conditions which prevail there. The O ring can be manufactured, for example, from fluoro rubber (FKM) or perfluoro rubber (FFKM). These materials are distinguished by low permeation.

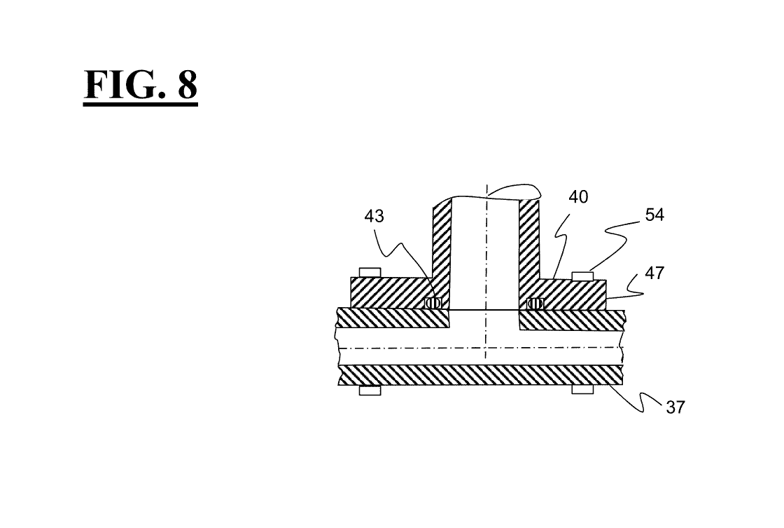

FIG. 8 shows a further exemplary embodiment of a cooler having a seal between the connection piece and the heat sink. This exemplary embodiment differs from the above-described exemplary embodiments in that the connecting element provided is a bracket 54, which engages around a flange 47 of the connection piece 40 and the heat sink 37 itself.

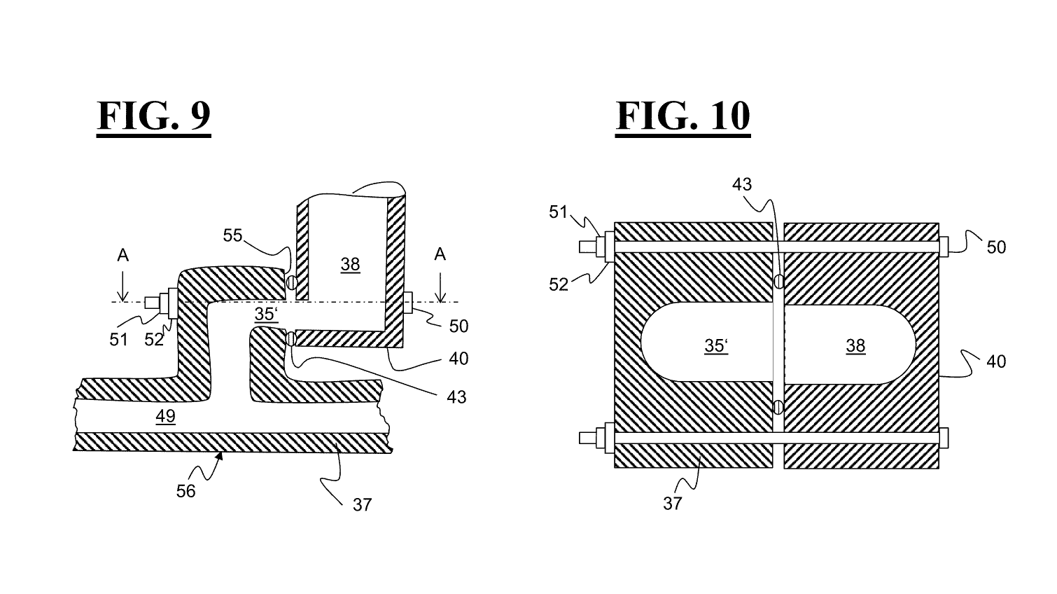

FIGS. 9 and 10 show a further exemplary embodiment of a cooler having a seal between the connection piece and the heat sink. In this exemplary embodiment, the coolant duct in the heat sink 37 is embodied offset toward a contact surface 55 for the connection body 40, the term “offset” meaning that a part 35′ of the coolant duct runs parallel or at an angle of less than 60° with respect to a main coolant duct 49 in the heat sink 37.

At the contact surface 55, the heat sink 37 is sealed off with respect to the connection body 40 by a first sealing element 43 and if appropriate a second sealing element as per one of the above-described exemplary embodiments.

FIG. 10 shows the connection between the heat sink 37 and the connection piece 40 in a section along the line A-A from FIG. 9. In this exemplary embodiment, the connecting elements are embodied as bolts 50 with nuts 51 and washers or backing pieces 52 and are arranged at least approximately parallel to the offset part 35′ of the coolant duct. The offset embodiment of the coolant duct makes it possible to design the heat sink 37 and/or the connection piece 40 in solid form at the site of the connecting element, that is to say to provide these with a comparatively large quantity of material along the axis of the connecting element. This reduces stresses in the material of the heat sink 37 and/or of the connection piece 40. This embodiment is expedient particularly when a ceramic material is used as the substrate material for the heat sink. It is generally recommended to embody connections with ceramic materials in such a way that pressure is exerted on the ceramic, since ceramic is considerably more sensitive to fracture for tensile stresses. However, in the case of such connections, tensile stresses, which can lead to component failure, also often arise in the immediate surroundings of a compressive stress. Tensile stresses are reduced or largely avoided by an embodiment as shown in FIGS. 9 and 10.

The embodiment as shown in FIGS. 9 and 10 is furthermore distinguished by the fact that the normal forces exerted on the first sealing element with the aid of the connecting elements act at least approximately parallel to and at a distance from the surface 56 from the surface 56 of the heat sink 37, via which the thermal load is taken up. The point of connection between the heat sink 37 and the connection piece 40 is decoupled from the surface 56, and therefore no or only few stresses arise in the surface. Instances of deformation of the surface 56 are thereby at least largely avoided. This is of particular importance when the surface 56 is in the form of an optically effective surface of an optical element.

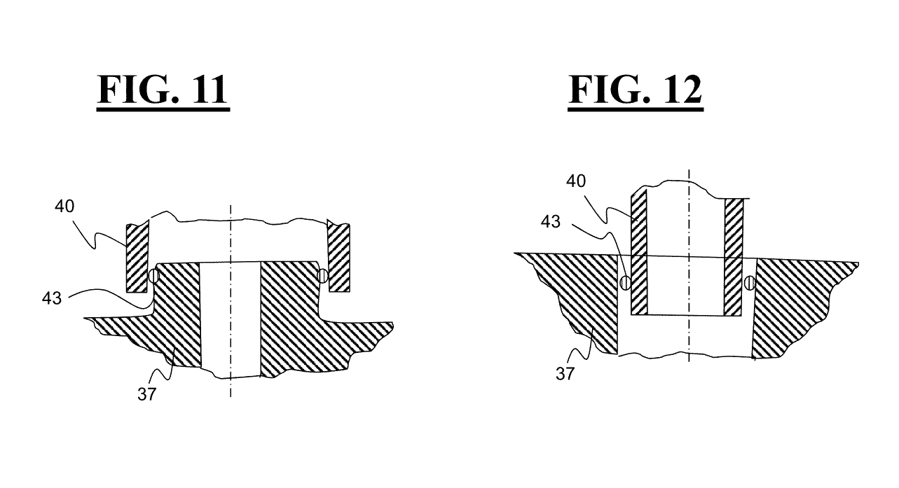

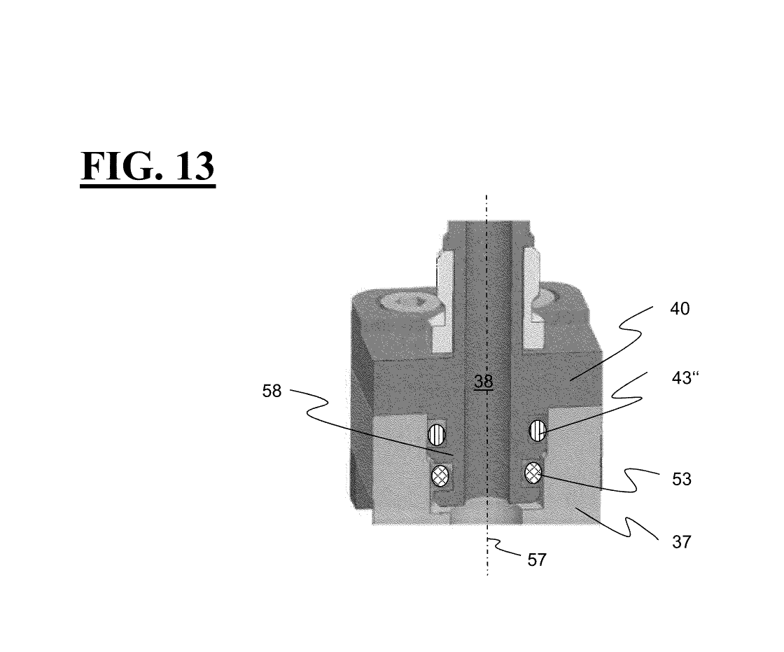

FIGS. 11 to 13 show further exemplary embodiments of a cooler having seals between the connection piece 40 and the heat sink 37. In these exemplary embodiments, the connection piece 40 is shrunk onto the heat sink 37 (FIG. 11) or alternatively screwed on or shrunk in (FIGS. 12 and 13) or alternatively screwed in. All sealing elements as per the above-described exemplary embodiments can be used as the first sealing element 43 and if appropriate as the second sealing element 53.

FIG. 13 shows a further exemplary embodiment of a cooler having seals between the connection piece 40 and the heat sink 37. In a manner similar to the exemplary embodiment as shown in FIG. 7, the cooler has a first sealing element 43″, which in this case is embodied as a gas-tight ring with an oval profile. A second sealing element is embodied as a liquid-tight O ring 53. In contrast to the exemplary embodiment as shown in FIG. 7, the connection piece 40 comprises a connector 58, which can be received in a reception opening 59 in the heat sink 37. The coolant line 38 is routed through the connector and opens out into an opening in an end face of the connector 58. The connection surfaces of the heat sink 37 and of the connection piece 40 for the first sealing element 43″ and the second sealing element 53 are formed axially in relation to the central axis 57 of the continuous line on an outer side of the connector 58. It should be pointed out that all of the other embodiments of the sealing elements which have been presented above can also be used in coolers with axial arrangements of the connection surfaces as shown in FIG. 13. This exemplary embodiment is distinguished by a particularly compact design combined with a highly effective seal.

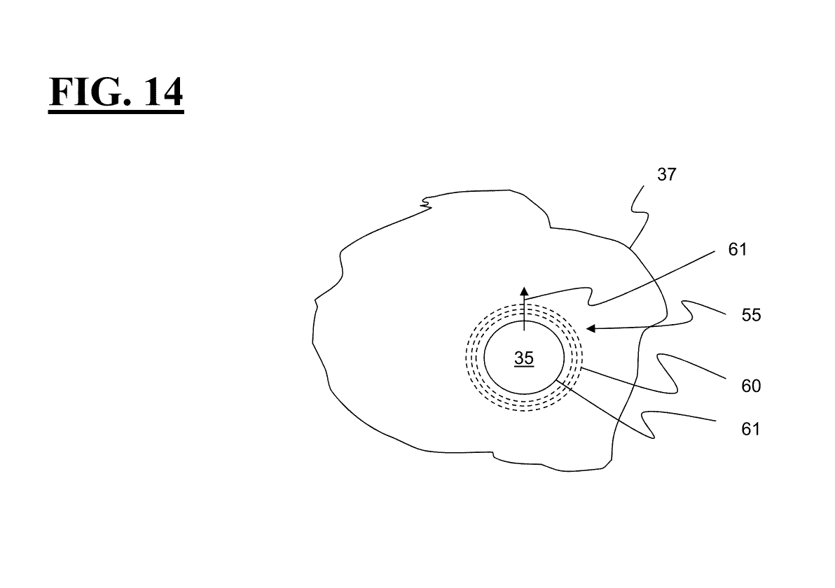

In all of the above-described exemplary embodiments, the connection surfaces for the first sealing element and if appropriate the second sealing element in the heat sink are preferably produced by a machining process which leads to microscopically small, concentric roughness structures in the surface. One example of such a surface structure is shown in FIG. 14. In this case, a connection surface 55 on a surface of the heat sink 37 around an outlet opening 61 of the coolant duct 35 has been machined via milling, the milling axis being oriented along the central axis of the coolant duct. This forms microscopically small grooves 60, which are oriented concentrically around the outlet opening 61 and which, in cooperation with the first sealing element, improve a sealing action in the radial direction 61 with respect to the central axis of the coolant duct 35. Suitable alternative surface machining processes are also other mechanical or chemical production processes which make it possible to generate generally microscopically small roughness structures in a contact surface for the sealing element with proportions in a non-radial direction with respect to the central axis of the coolant duct or of the coolant line, such as grinding or erosion.

The high thermal loads which occur in plasma generation chambers of EUV projection exposure apparatuses often involve the use of coolers in order to dissipate the heat. The coolers in this case are to withstand fluctuating thermal loads and also bombardment with particles and should nevertheless have at most a low leakage rate in the prevailing vacuum environment. In order to ensure reliable operation of the plasma generation chamber, it should be ensured in particular that no or only little coolant or coolant constituents pass into the vacuum environment. Therefore, particularly high demands should be placed on the embodiment of the connections between the coolers and the connection lines.

The cooler according to the disclosure is distinguished by a particularly high quality of the seal under the conditions which prevail in plasma generation chambers. The quality of a seal can be determined with the aid of the leakage rate upon filling with helium. The leakage rate Q₁ is defined here as Q₁=(Δp*V)/Δt, where Δp=pressure difference, V=fill volume and Δt=measurement time. The cooler according to the disclosure makes it possible to achieve leakage rates of less than 10⁻⁵ mbar*l/s, in particular also of less than 10⁻⁶ mbar*l/s. In addition, the cooler according to the disclosure is distinguished by a very small permeation of water and oxygen.

Compared to conventional, integral connections between the connection piece and the heat sink, such as welding, soldering or adhesive bonding, the use of a first sealing element made of a metallic material or a metal alloy moreover has the advantage that no cavities form in a connecting layer during production of the cooler. Cavities in known integral connections entail the risk that the enclosed gas escapes over time into the vacuum environment in the plasma generation chamber and thereby impairs the function of the plasma generation chamber.

Finally, the cooler according to the disclosure is distinguished by the fact that the connection pieces can be separated from the heat sink at room temperature, for example for repair purposes. In contrast to this, conventional soldered or welded connections have to be heated, which can lead to damage to the cooler and in particular also to optical elements which may be connected to the cooler.

The disclosure has been described above with reference to a cooler for use in a plasma generation chamber of a radiation source for the extreme ultraviolet wavelength range. In alternative embodiments, the cooler or a component with such a cooler may generally be provided in all kinds of vacuum chambers, in which plasma is generated or introduced from outside. Such vacuum chambers are present, for example, in ion or plasma sources or sputter devices or magnetron sputter sources.

What is claimed is:

1. A cooler, comprising:
a heat sink comprising a substrate material having a thermal conductivity of greater than 50 W/mK, the heat sink including a coolant duct comprising the substrate material, the coolant duct being configured to have coolant flow therethrough;
a connection piece configured to connect a coolant line to the coolant duct, the connection piece comprising a material selected from the group consisting of a metal and a metal alloy;
a connecting element connecting the connection piece to the heat sink so that, when the connection piece connects the coolant duct to the coolant line, the coolant duct and the coolant line define a continuous line;
a first sealing element comprising a material selected from the group consisting of a metallic material, the first sealing element being between the heat sink and the connection piece being configured so that, when the connection piece connects the coolant duct to the coolant line, the first sealing element surrounds to the continuous line; and
a device configured to protect the first sealing element against corrosion,
wherein the cooler is configured to be used in a plasma generation chamber of an EUV radiation source.

2. The cooler of claim 1, wherein the substrate material comprises a ceramic.

3. The cooler of claim 2, wherein the heat sink has a contact surface for the first sealing element, and the contact surface comprises concentric roughness structures.

4. The cooler of claim 3, wherein the heat sink comprises a first flange, the connection piece comprises a second flange, the heat sink and the connection piece are connected to one another via the first and second flanges, and the connecting element is configured to exert normal forces on opposing surfaces of the first and second flanges.

5. The cooler of claim 2, wherein the heat sink comprises a first flange, the connection piece comprises a second flange, the heat sink and the connection piece are connected to one another via the first and second flanges, and the connecting element is configured to exert normal forces on opposing surfaces of the first and second flanges.

6. The cooler of claim 1, wherein the heat sink comprises a first flange, the connection piece comprises a second flange, the heat sink and the connection piece are connected to one another via the first and second flanges, and the connecting element is configured to exert normal forces on opposing surfaces of the first and second flanges.

7. The cooler of claim 1, wherein the substrate material comprises a material selected from the group consisting of a metal, a metal alloy and a metal composite.

8. The cooler of claim 1, wherein the first sealing element has a cross section that is a closed hollow profile or and open hollow profile.

9. The cooler of claim 1, wherein the device comprises a second sealing element which is liquid-tight and which, when the connection piece connects the coolant duct to the coolant line, surrounds the continuous line.

10. The cooler of claim 9, wherein the second sealing element comprises an O ring.

11. The cooler of claim 10, wherein the heat sink has a contact surface for the second sealing element, and the contact surface has concentric roughness structures.

12. The cooler of claim 11, wherein the heat sink has a contact surface for the first sealing element, and the contact surface for the first sealing element comprises concentric roughness structures.

13. The cooler of claim 9, wherein the heat sink has a contact surface for the second sealing element, and the contact surface has concentric roughness structures.

14. The cooler of claim 13, wherein the heat sink has a contact surface for the first sealing element, and the contact surface for the first sealing element comprises concentric roughness structures.

15. The cooler of claim 1, wherein the device comprises a corrosion-inhibiting coating.

16. A system, comprising:
an optical element comprising a cooler, the cooler comprising:
a heat sink comprising a substrate material having a thermal conductivity of greater than 50 W/mK, the heat sink including a coolant duct comprising the substrate material, the coolant duct being configured to have coolant flow therethrough;
a connection piece configured to connect a coolant line to the coolant duct, the connection piece comprising a material selected from the group consisting of a metal and a metal alloy;
a connecting element connecting the connection piece to the heat sink so that, when the connection piece connects the coolant duct to the coolant line, the coolant duct and the coolant line define a continuous line;
a first sealing element comprising a material selected from the group consisting of a metallic material, the first sealing element being between the heat sink and the connection piece being configured so that, when the connection piece connects the coolant duct to the coolant line, the first sealing element surrounds to the continuous line; and
a device configured to protect the first sealing element against corrosion.

17. The system of claim 16, wherein the optical element comprises a reflective optical element.

18. A system, comprising:
a plasma generation chamber of an EUV radiation source, the plasma generation chamber comprising a cooler, the cooler comprising:
a heat sink comprising a substrate material having a thermal conductivity of greater than 50 W/mK, the heat sink including a coolant duct comprising the substrate material, the coolant duct being configured to have coolant flow therethrough;
a connection piece configured to connect a coolant line to the coolant duct, the connection piece comprising a material selected from the group consisting of a metal and a metal alloy;
a connecting element connecting the connection piece to the heat sink so that, when the connection piece connects the coolant duct to the coolant line, the coolant duct and the coolant line define a continuous line;
a first sealing element comprising a material selected from the group consisting of a metallic material, the first sealing element being between the heat sink and the connection piece being configured so that, when the connection piece connects the coolant duct to the coolant line, the first sealing element surrounds to the continuous line; and
a device configured to protect the first sealing element against corrosion.

19. The system of claim 18, further comprising an optical element, the optical element comprising the cooler.

20. The system of claim 19, wherein the optical element comprises a reflective optical element.
